(19) United States
(12) Patent Application Publication
(10) Pub. No.: US 2006/0211128 A1
(43) Pub. Date: Sep. 21, 2006

(54) Crude unit desalter emulsion level detector

(75) Inventors: Glenn A. Johnson, Devon, PA (US); Peter S. Allison, Conroe, TX (US); Thomas James Batzinger, Burnt Hills, NY (US); Gregory L. Powers, Simsbury, CT (US)

Correspondence Address: HOFFMANN & BARON, LLP, 6900 JERICHO TURNPIKE, SYOSSET, NY, 11791, US

(73) Assignee: General Electric Company

(21) Appl. No.: 11/075,505

(22) Filed: Mar. 9, 2005

(51) Int. Cl. G01N 24/00

(52) U.S. Cl. 436/173

(57) ABSTRACT

The present invention is directed to a method for determining an emulsion layer within a container comprising, initiating an ultrasonic signal from at least one transmitter through a liquid contained within a tank, receiving the signal at a receiver, measuring the time of flight of the signal, calculating the velocity of the ultrasonic signal, determining the composition of the liquid in the tank; and correlating the composition to an emulsion ratio.

### BACKGROUND OF THE INVENTION

1. Field of the Invention

This invention relates to an emulsion layer level detector to monitor and control the profile of an emulsion layer within a desalter tank to maintain the proper balance of constituents within the tank.

2. Description of Related Art

The first processing step in a crude oil refinery operation is Crude Distillation, wherein crude oil is distilled into “rough” fractions.

This operation is commonly referred to as the Crude Distillation Unit (CDU) and the Atmospheric Distillation Unit (ADU). In simple terms, the crude oil is normally pumped through a series of heat exchangers, into a distillation column. The distillation column splits the crude oil into “rough” fractions sometimes referred to as cuts. A typical set of cuts from this operation could be for example inerts, gas and light ends (naphtha); kerosene and diesel (or gasoil) residue.

However, to enhance the crude separation process, some pre-conditioning of the crude oil is normally required. Some examples of pre-conditioning steps include; Desalting, where the salt (solids) content of the crude oil stream is reduced; Pre-Heating, which involves the use of heat exchangers to increase the temperature of the crude oil stream, and vaporizing, which is typically done using a fired heater, which is located directly in front of the distillation column. Typically, crude oil distillation is performed at a pressure of 0-5 bar. The temperature and pressure profile of the distillation column is selected to ensure the maximum separation efficiency to give the required products.

Desalting is carried out by emulsifying the crude oil with water at about 250 degrees and under sufficient pressure to prevent vaporization of either water or hydrocarbons. The salts are dissolved in the water and the water and oil phases separated by using chemicals to break the emulsion and/or by developing a high potential electric field across the settling vessel to coalesce the droplets of salty water more rapidly. Electric potentials from 16,000 to 35,000 volts are used to promote coalescence.

The salt content of the crude is normally reduced 90 percent or more in a one- stage operation. Additional stages can be used in series to reduce the salt content further if one stage of desalting is inadequate.

After desalting, the crude oil is pumped through a series of heat exchangers and it temperature raised to about 550 degrees by heat exchange with product and reflux streams.

The resultant fractions or cuts are taken as products from the crude distillation section for further processing in downstream refinery units.

The desalting process is required in part because crude oils often have many salts dissolved in them, which result in high chloride levels in the regions downstream of the distillation column. These chlorides can cause rapid and severe corrosion of pipe walls, heat exchanger tubes and shell, and other carbon steel components in which they come in contact during processing. Theses salts are typically removed by creating a water/oil emulsion which is subsequently broken in a large tank, sometimes referred to as a desalter. In this process the salts and other solids are stripped from the oil. The salt removal process depends on controlling the emulsion layer in the desalter with an oil layer above it and a water layer below. Loss of the proper balance of any of theses layers results in too much oil being lost with the wash water, too much water being retained in the oil or non-removal of the chlorides.

Furthermore, the environment inside of desalting systems used in the refinement of crude oil can be an especially harsh environment in which many materials commonly used in the construction for devices such as ultrasonic probes would either corrode or fail to perform to the original capability after a very short time. It is typical for the desalter to be in operation for four or more years without shutdown for maintenance. This lengthy maintenance interval requires that any system and components used for measuring the emulsion level within a desalter environment must be capable of continuous operation for this period of time.

In prior art systems the extent and composition of the emulsion layer is determined by petcocks placed at various heights in the tank. Fluid is drained from the tank by manual operation of the petcocks and the effluent stream is visually examined to determine the proportion of water and oil. Adjustments are then made to the flow and pressure of the incoming water stream based on the observations of the petcock output. Typically, this is done on a daily basis and may include laboratory analysis of the petcock output to confirm visual observations. The results of the laboratory analysis can sometimes take several hours thereby delaying operational changes to the desalter based on the results. Additionally, by the time the results of the laboratory analysis are available, the conditions in the desalter may have changed, and the operational adjustments may not result in the desired emulsion layer balance.

It would therefore be desirable to have an emulsion layer detector that can provide accurate data regarding the emulsion layer composition. Additionally, it would be desirable to have an emulsion layer detector that can function reliably in the harsh environment of a desalter tank without structural or instrument degradation for several years without the need for maintenance. Furthermore, it would be desirable to have an emulsion layer detector that can provide real time data regarding the emulsion layer balance that can be used for continuous real time monitoring of operational conditions in an emulsion tank as part of a closed feedback control loop for constant operational adjustments of conditions within the tank.

### SUMMARY OF THE INVENTION

The present invention is therefore directed to a method for determining an emulsion layer within a container comprising, initiating an ultrasonic signal from at least one transmitter through a liquid contained within a tank, receiving the signal at a receiver, measuring the time of flight of the signal, calculating the velocity of the ultrasonic signal, determining the composition of the liquid in the tank; and correlating the composition to an emulsion ratio.

According to the invention, there is provided a system and method for determining the composition of a fluid in a container by means of ultrasonic wave measurement in which waves are generated and transmitted from an ultrasonic wave transmitter through a fluid, in this case an oil and water emulsion, and are received in an ultrasonic wave receiver. The present invention includes a plurality of transmitters and the receivers which are rigidly mounted within a container at a predetermined distance. Because the distance between the transmitter and receiver (the propagation distance) is known, it is possible to determine the absolute velocity of the ultrasonic wave, which is related to the physical properties of the fluid through which the wave propagates. The system comprises a plurality of ultrasonic transmitter receiver pairs mounted vertically within a container, wherein each transmitter and receiver are separated by a predetermined distance. Each set of transmitter/receiver pairs are aligned along the interior of the container at regular intervals such that data on the physical properties of the fluid can be ascertained along a stratified region.

The system and method of the current invention comprises measurement of the time required for sound to propagate from the transmitter to the receiver. This propagation time is used in conjunction with the distance between the transmitter and receiver to calculate the acoustic velocity of the emulsion at various elevations within the desalter. The acoustic velocity is directly related to the percent of water in the emulsion which is used to determine the location of the emulsion layer within the desalter.

More particularly, the current invention comprises transmitting a broadband pulse through one transducer, receiving the pulse through the opposite transducer, and measuring the elapsed time between the transmission and reception of the pulse.

### BRIEF DESCRIPTION OF THE DRAWINGS

FIG. 1 is a cross sectional diagram of a desalter tank in accordance with the present invention.

FIG. 2 is a schematic diagram of the emulsion level detector according to the present invention.

FIG. 3 is a cross sectional diagram of the transducer support member according to the present invention.

FIG. 4 is a cross sectional diagram of a desalter tank in accordance with the present invention.

FIG. 5 is a graph depicting the relationship of acoustic velocity to temperature in accordance with the principles of the present invention.

### DETAILED DESCRIPTION OF THE PREFERRED EMBODIMENT

There will be detailed below the preferred embodiments of the present invention with reference to the accompanying drawings. Like members are designated by like reference characters in all figures.

The present invention is directed to an emulsion layer detector that can provide accurate data regarding the emulsion composition. The invention is based upon the principle that waves, more particularly sound waves move through fluids at different rates depending on the composition of the medium through which it travels.

The invention uses a direct coupled ultrasonic sensor in a pulse echo or through transmission mode to measure the emulsion ratio of the crude oil and water in the tank. Since the velocity of sound in crude oil is about 10% slower than in water, the time of flight in crude oil is about 10% longer than that through water. The time of flight in an emulsion is approximately proportional to the ratio of oil to water. By measuring the time of flight of the ultrasonic wave at different heights in the tank, a profile of the oil/ water ratio can be determined usually to within ±15%. This data can then be used to control both the water flow and the emulsion valve settings providing closed loop control of the emulsion layer in the desalter.

Because the speed of the wave propagation is given by the function wherein speed, and composition are variable, it is possible to solve for one of the variables when the others are know. In the case of this invention, the distance is between sensors is known, and the velocity of wave propagation is a function of the composition of the fluid. In that way, it is possible to measure the composition of the fluid by initiating a wave from a particular point in a vessel and measuring the time it takes to propagate to a sensor separated by a known distance

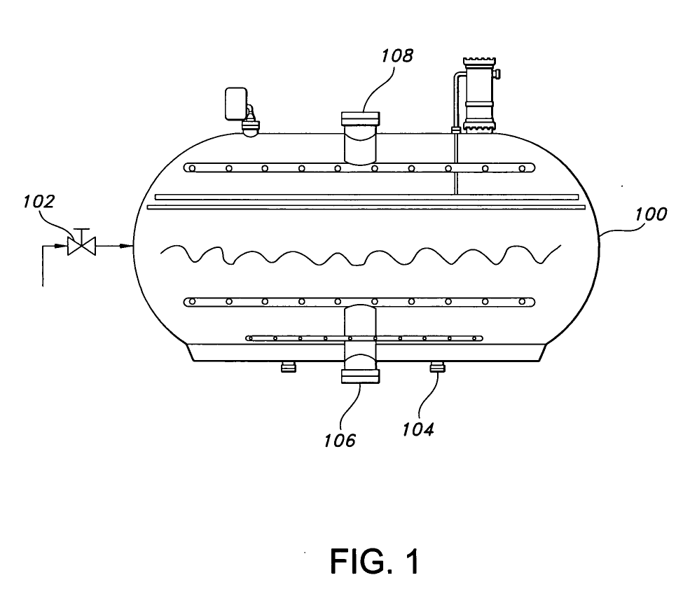

Turning now to FIG. 1, there is shown a schematic diagram of the emulsion desalter tank. The emulsion desalter tank depicted includes a liquid tight tank 100 for carrying out the desalting operation. The tank 100 includes an emulsion inlet 102, and water and oil outlets, 106 and 108 respectively. As previously described, during operation, an emulsion of water and oil is formed at 102 and injected into 100, where it forms a layer, sometimes referred to as a “Rag Layer”, between the oil and water already in the tank. The separated water and oil are then removed from tank 100 by the outlets. Oil, being separated to the top of the emulsion is removed by oil outlet 108. Likewise, water being separated to the bottom of tank 100 is removed by water outlet 106.

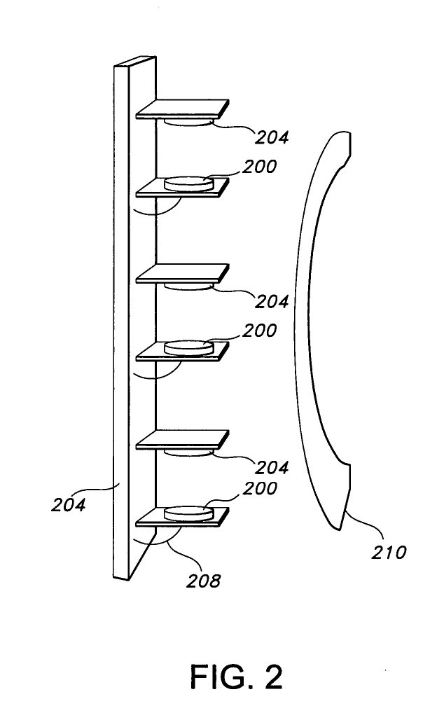

Turning now to FIG. 2, there is shown a schematic diagram of the emulsion level detector according to the present invention. The present invention includes a plurality of vertically oriented transmitter 200 and receiver 202 pairs for mounting within an emulsion tank. In the example depicted, the transmitter and receiver pairs are mounted on a stanchion, 204 which would be rigidly affixed to the inside of an emulsion tank. The transmitter and receivers are mounted on the stanchion 204 by a support beam 206. As shown the stanchion 204 can be substantially straight or curved 210 to conform to the radius of curvature for any tank to which it would be affixed. The stanchion would support a plurality of transmitters and receiver pairs oriented vertically along the stanchion where each transmitter and receiver pair are oriented toward one another. More specifically, the transmitter and receiver pairs are oriented such that a sound wave is passed between the pair. The transmitter and receiver pair are mounted a predetermined distance from each other, for example one inch apart and each pair is mounted a predetermined distance from each other. The distance between each pair can be varied in order to obtain data regarding the composition of the emulsion at a particular level in the desalter tank. It would be apparent to one skilled in the art that the number and distance of transmitter/receiver pairs can be varied depending on the number and location of composition readings desired. Greater precision in determining the emulsion level can thus be obtained by increasing the number of detector pairs within the emulsion tank, by decreasing the distance separating those pairs. The time of flight of the sound wave between a particular receiver pair is measured and calculated by a controller/acquisition /processor system (not shown) connected to each transmitter and receiver by a cable 208. It is further noted that the wave is sent only from each transmitter to its corresponding receiver where it is received. The wave is not reflected back to the transmitter, the time of flight is measured solely on the basis of its transit time from a transmitter to the corresponding receiver. Alternatively, a pulse-echo embodiment could be used in which the pulse is reflected back to the transmitting transducer.

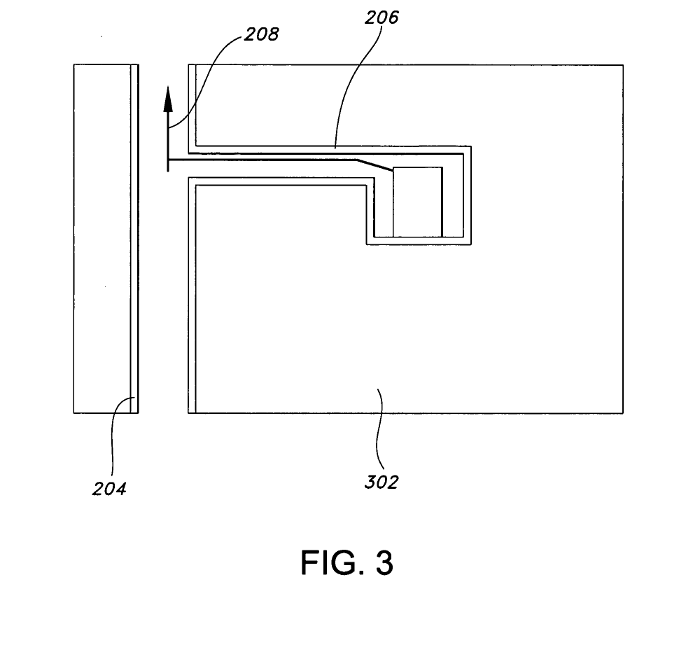

Turning now to FIG. 3, there is shown a cross sectional diagram of stanchion 204 and support beam 206 for an ultrasonic transmitter 200 in accordance with the current invention. The ultrasonic transmitter is connected to a central controller (not shown) by an electrical conductive cable 208. In the embodiment depicted, the transmitter is shown encapsulated within a hollow stanchion and support, which could be made of stainless steel or other suitable material that would rigidly support the ultrasonic transmitters and receivers, but also isolate those components from the corrosive environment 302 of the desalter tank. Wetted probes could also be used.

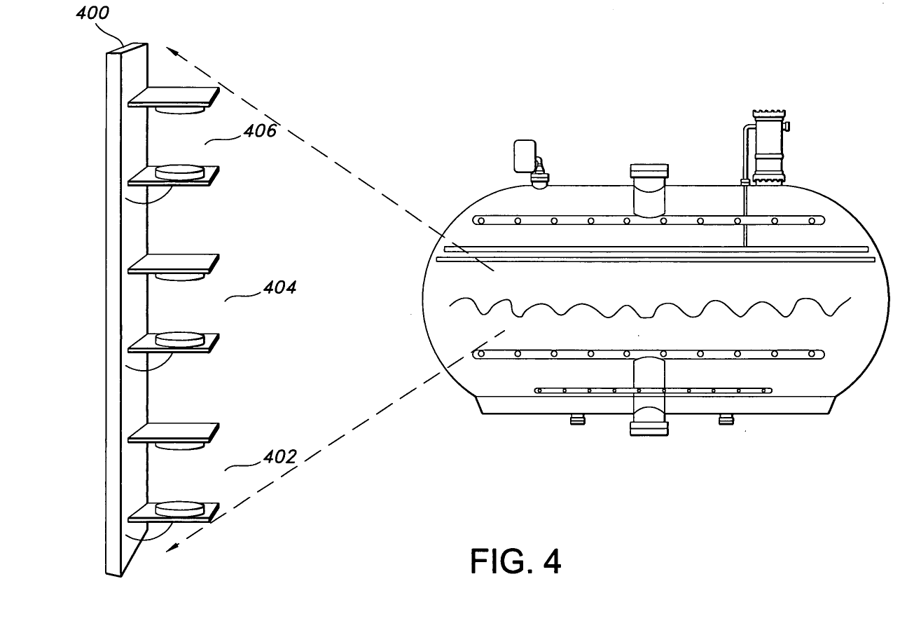

Turning now to FIG. 4, there is shown a cross sectional schematic diagram of the emulsion desalter depicting the acoustic transducer mounting stanchion together with a plurality of ultrasonic transmitters and receiver pairs. In the depicted version three ultrasonic receiver and transmitter pair are depicted, 402, 404, 406 however, any number of transmitter receiver pairs are possible within the scope of this invention. The number of pairs can be varied to accommodate the size of emulsion tank in which the detector is used. Further depicted in FIG. 4 is a proposed location and orientation of the detector stanchion assembly according to the present invention. The assembly is preferably located vertically along the inside of the tank wall, with detector pairs arranged at predetermined intervals. In a particular embodiment, the receiver/transmitters pairs are located approximately 1 inch apart, with a vertical distance of approximately 6-8 inches between pairs. However, these distances are exemplary and can be varied without departing from the spirit of the invention. In this way, the detector pairs are located in a series of vertically stratified bands within the emulsion tank. This enables the detectors to not only determine the composition of the emulsion, but also the composition profile within the tank at various levels within the emulsion in real time. This provides a benefit over prior art systems in that a real time “snapshot” of the emulsion composition can be obtained and thus the desalter operation modified to achieve the results desired.

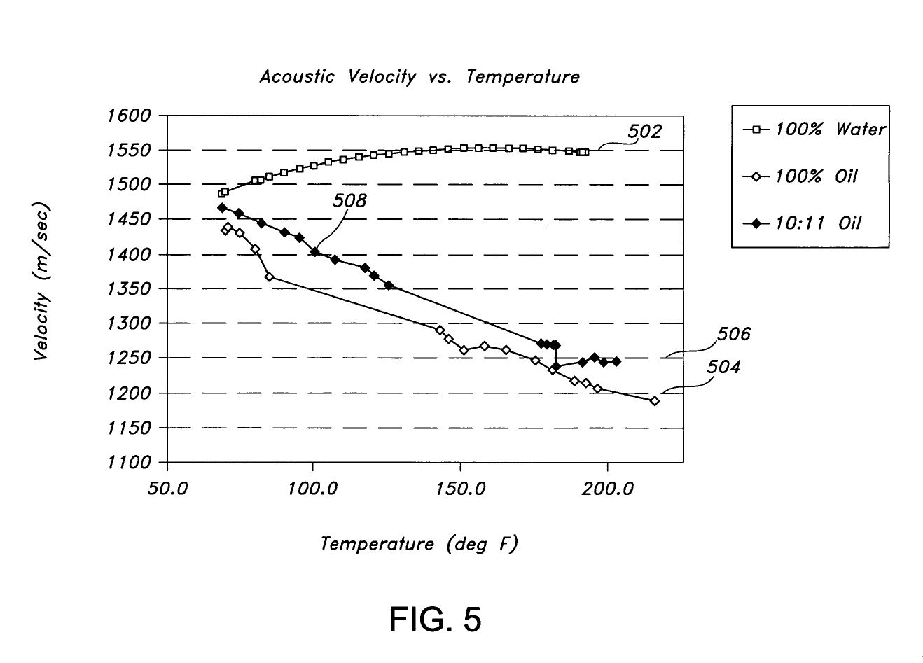

Turning now to FIG. 5, there is shown a graph of the Acoustic Velocity of a wave propagating in a water/oil emulsion vs. the temperature of the emulsion. The graph depicts a curve for wave velocity at a particular temperature for 100% water 502, 100% oil 504 and a mixture of 10:11 Oil 506. By referencing the graph, the emulsion ratio can be determine by obtaining measurements of the temperature of an emulsion, and the velocity of wave propagation. For example, by obtaining a measurement of 100 deg. F. and a velocity of 1400 m/sec, the emulsion ratio can be determined as 10:11 by referencing curve 506 and more particularly point 508. One skilled in the art would understand that it would be possible to determine and plot alternate emulsion ratios other than those depicted herein.

Additionally, alternate frequencies may be used for the ultrasonic wave. In principle, any frequency can be used without any effect on the results. Frequencies between 500 kHz and 10 MHz could be used without a significant change in the results

The programmable logic controller (PLC), which is not shown, is provided for controlling: (i) initiating an ultrasonic signal from at least one of the transmitters; (ii) receiving a signal from a receiver that the sound wave has been received; (iii) measuring the time of flight of the sound wave; (iv) calculating the velocity of the sound wave (vi) determining the composition of the liquid in the tank; (vii) correlating the composition to an emulsion ratio; and (viii) adjusting the emulsion ratio in accordance with the process parameters. The programmable logic controller stores emulsion ratio's , composition data and other process parameters input by an operator. The programmable logic controller then uses the input data to control the emulsion ratio. The profile data would be fed to the plant control system and could be displayed in real time to a plant operator. Control logic could be placed in the control system to automatically control the emulsion valve position and water flow based on the profile data, thereby creating a closed loop controller for the desalter.

It will be appreciated that the present invention has been described herein with reference to certain preferred or exemplary embodiments. The preferred or exemplary embodiments described herein may be modified, changed, added to or deviated from without departing from the intent, spirit and scope of the present invention. It is intended that all such additions, modifications, amendments, and/or deviations be included within the scope of the claims appended hereto.

What is claimed is:

1) A method for determining an emulsion layer within a container comprising;
initiating an ultrasonic signal from at least one transmitter through a liquid composition contained within a tank;
receiving said signal at a receiver;
measuring the time of flight of said signal from said transmitter to said receiver;
correlating the time of flight to a percentage of water in said liquid composition.

2) A method for determining an emulsion layer within a container as in claim 1 further including placing a plurality of said transmitters and said receivers vertically within said container.

3) A method for determining an emulsion layer within a container as in claim 1 further including initiating an ultrasonic signal from more than one transmitter and receiving said ultrasonic signals at more than one receiver.

4) A method for determining an emulsion layer within a container as in claim 1 further including correlating a plurality of time of flight measurements to a percentage of water in said liquid composition.

5) A method for determining an emulsion layer within a container as in claim 4 wherein said plurality of time of flight measurements are correlated to a horizontal region within said container.

6) A method for determining an emulsion layer within a container as in claim 1 further including correlating the time of flight to a percentage of water in said liquid composition in real time.

7) A method for determining an emulsion layer within a container as in claim 6 further including adjusting the percentage of water in said liquid composition in response to said percentage of water in said liquid composition.

8) A method for determining an emulsion layer within a container as in claim 7 further including adjusting the percentage of water in said liquid composition in real time.

9) A system for determining an emulsion layer within a container comprising;
a vessel for containing an emulsified liquid;
at least one pair of ultrasonic transmitters and receivers rigidly mounted within said vessel and separated by a predetermined distance for transmitting and receiving an ultrasonic signal through said emulsified liquid; and
a central controller connected to said ultrasonic transmitters and receivers for measuring the time of propagation of said ultrasonic wave from transmission to reception, calculating the time of flight of said ultrasonic signal and correlating said time of flight to a percentage of water in said liquid composition.

10) A system for determining an emulsion layer within a container as in claim 9 further comprising a plurality of pairs of ultrasonic transmitters and receivers rigidly mounted within said vessel.

11) A system for determining an emulsion layer within a container according to claim 9 further including adjusting means connected to said container for changing said percentage of water in said liquid composition.

12) A system for determining an emulsion layer within a container as in claim 9 wherein each pair of said ultrasonic transmitters and receivers is separated by a predetermined vertical distance.

13) A system for determining an emulsion layer within a container as in claim 9 further comprising a feedback loop connected to said controller and said adjusting means for providing real time control of the percentage of water in said liquid composition.
